(19) United States
(12) Patent Application Publication
(10) Pub. No.: US 2026/0331564 A1
(43) Pub. Date: Oct. 22, 2026

(54) SOLID ELECTROLYTE SHEET, MANUFACTURING METHOD FOR SAME, AND LITHIUM SECONDARY BATTERY COMPRISING SAME

(71) Applicant: RESEARCH INSTITUTE OF INDUSTRIAL SCIENCE AND TECHNOLOGY, Pohang-si (KR)

(72) Inventors: Gwangseok OH, Incheon (KR); Ohmin KWON, Incheon (KR); Sang Cheol NAM, Seoul (KR)

(21) Appl. No.: 19/119,533

(22) PCT Filed: Sep. 19, 2023
(86) PCT No.: PCT/KR2023/014210

§ 371 Date: Apr. 9, 2025

(30) Foreign Application Priority Data
Nov. 21, 2022 (KR) 10-2022-0156676

(51) Int. Cl. H01M 10/0562; B60L 50/64; H01M 10/0525

(52) U.S. Cl. CPC H01M 10/0562; B60L 50/64; H01M 10/0525; H01M 2220/20; H01M 2300/008; H01M 2300/0094

(57) ABSTRACT

The present invention relates to a solid electrolyte sheet including a first solid electrolyte layer and a second solid electrolyte layer positioned on the first solid electrolyte layer, wherein the first solid electrolyte layer includes a first solid electrolyte, the second solid electrolyte layer includes a second solid electrolyte, and a density of the first solid electrolyte is greater than a density of the second solid electrolyte.

### FIELD OF THE INVENTION

The present invention relates to a solid electrolyte sheet, a manufacturing method thereof, and a lithium rechargeable battery including the same, and more specifically, to a solid electrolyte sheet using two different kinds of solid electrolytes, a manufacturing method thereof, and a lithium rechargeable battery including the same.

### DESCRIPTION OF THE RELATED ART

Research on the safety issues and energy density of high-capacity batteries is attracting attention, and all-solid batteries are attracting attention as the next generation battery. The all-solid-state battery is a battery that ensures battery safety because it replaces the liquid electrolyte that causes explosion with a solid electrolyte, and does not use flammable solvents in the battery, so there is no risk of ignition or explosion due to reactions such as the decomposition reaction of conventional electrolytes.

In addition, since lithium metal or lithium alloy can be used as the negative electrode material, the energy density for the mass and volume of the battery can be improved. The solid electrolyte used in the solid battery is generally an inorganic solid electrolyte, and various studies are being conducted on the sulfide-based solid electrolyte with a composition such as Li₆PS₅Cl, which has an argyrodite structure among the solid batteries.

In order to commercialize solid batteries, large-area batteries must be manufactured. To manufacture large-area solid batteries, it is essential to form sheets of the positive electrode, separator, and negative electrode, as in the case of existing lithium ion batteries. In particular, the separator is composed of a solid electrolyte and a binder, and its characteristics (ion conductivity, electrochemical stability, chemical stability) vary depending on the manufacturing method and the material of the selected solid electrolyte.

In the case of a solid battery, the solid electrolyte for the positive electrode composite and the solid electrolyte for the negative electrode composite can be used separately. The solid electrolyte used in the positive electrode composite requires small particles to form a wide contact area with the positive electrode active material, and a material that has low interface resistance with the positive electrode and is stable at high voltage is required. On the other hand, the negative electrode composite must have a wide contact with the negative electrode active material, form a stable interface with the negative electrode material (lithium, silicon, graphite), and use a solid electrolyte that has stable characteristics at low voltage.

Therefore, the solid electrolyte sheet that acts as a separator between the positive electrode and the negative electrode in a solid battery must be made of a solid electrolyte material that has low interface resistance between the positive electrode and the negative electrode.

### SUMMARY OF THE INVENTION

The embodiment of the present invention is to provide a solid electrolyte sheet that has excellent ion conductivity and excellent electrochemical characteristics when applied to a lithium rechargeable battery, as it has a small interface resistance between the positive electrode active material and the negative electrode active material, can form a wide contact area, and has excellent voltage stability.

Another embodiment of the present invention is to provide a manufacturing method of a solid electrolyte sheet having the advantages of simple process, excellent process efficiency, and the like.

Another embodiment of the present invention is to provide a lithium rechargeable battery comprising a solid electrolyte sheet having the advantages.

One embodiment of the present invention provides a solid electrolyte sheet, which includes a first solid electrolyte layer and a second solid electrolyte layer disposed on the first solid electrolyte layer, wherein the first solid electrolyte layer includes the first solid electrolyte, the second solid electrolyte layer includes the second solid electrolyte, and a density of the first solid electrolyte is greater than the density of the second solid electrolyte, and a difference in the density of the first solid electrolyte and the second solid electrolyte is 0.15 to 1.65 g/cc.

The density of the first solid electrolyte can be 1.4 to 3.4 g/cc.

The density of the second solid electrolyte can be 1.1 to 2.1 g/cc.

The weight ratio of the first solid electrolyte and the second solid electrolyte can be 3:7 to 7:3.

The first solid electrolyte can be a halide-based solid electrolyte, a sulfide-based solid electrolyte, or a combination thereof.

The sulfide-based solid electrolyte can have an argyrodite crystal structure.

The halide-based solid electrolyte is represented by the following formula 1, and the sulfide-based solid electrolyte has an argyrodite crystal structure and can be represented by the following formula 2.

LiₓM_{y}A_{z} [Chemical Formula 1]

Li₆₋ₓPS₅₋ₓD₁₊ₓ [Chemical Formula 2]

In the above formula 1, M is Sc, In, Zr, Lu, Er, Y, Ho or combination thereof, A is F, Cl, Br, I or combination thereof, 1.5≤x≤3.5, 0.5≤y≤1.5, 5≤z≤7,

In the above formula 2, 0≤x≤1, and D is F, Cl, B, I or combination thereof.

The second solid electrolyte may be a sulfide-based solid electrolyte.

The sulfide-based solid electrolyte has an argyrodite crystal structure and can be represented by the following formula 3.

Li₆₋ₓPS₅₋ₓE₁₊ₓ [Chemical Formula 3]

In the above formula 3, 0≤x≤1, and E is F, Cl, B, I or combination thereof.

Another embodiment of the present invention provides a method for manufacturing a solid electrolyte sheet, comprising the steps of: forming a composition including a first solid electrolyte, a second solid electrolyte, a solvent, and a binder; applying the composition onto a substrate; and drying the applied composition to form a solid electrolyte sheet, wherein a density of the first solid electrolyte is greater than a density of the second solid electrolyte, and a difference in the density of the first solid electrolyte and the second solid electrolyte is 0.15 to 1.65 g/cc.

The density of the first solid electrolyte can be 1.4 to 3.4 g/cc.

The density of the second solid electrolyte can be 1.1 to 2.1 g/cc.

The weight ratio of the first solid electrolyte and the second solid electrolyte can be 3:7 to 7:3.

The step of forming a solid electrolyte sheet by drying the applied composition is performed that: the first solid electrolyte and the second solid electrolyte are separated by a difference in density, and the second solid electrolyte comprising the second solid electrolyte is arranged on the first solid electrolyte layer comprising the first solid electrolyte, during the drying.

Another embodiment of the present invention provides an electrochemical cell including a positive electrode; a negative electrode; and a solid electrolyte sheet positioned between the positive electrode and the negative electrode, wherein the solid electrolyte sheet includes a first solid electrolyte layer and a second solid electrolyte layer disposed on the first solid electrolyte layer, wherein the first solid electrolyte layer includes a first solid electrolyte, the second solid electrolyte layer includes a second solid electrolyte, a density of the first solid electrolyte is greater than a density of the second solid electrolyte, and a density difference between the first solid electrolyte and the second solid electrolyte is 0.15 to 1.65 g/cc, and the first solid electrolyte layer is positioned on the positive electrode side and the second solid electrolyte layer is positioned on the negative electrode side.

Another embodiment of the present invention provides an electric vehicle comprising the electrochemical cell.

According to an embodiment of the present invention, a solid electrolyte sheet has a small interface resistance for the positive electrode and negative electrode active materials of a battery, a wide contact area, and excellent voltage stability by appropriately controlling the density and composition of the first solid electrolyte and the second solid electrolyte, so that the ion conductivity is excellent and the electrochemical characteristics of a battery using the same are excellent.

A manufacturing method of a solid electrolyte sheet according to another embodiment of the present invention has excellent process efficiency due to the difference in density between the first solid electrolyte and the second solid electrolyte.

### BRIEF DESCRIPTION OF THE DRAWINGS

FIG. 1 is a schematic cross-sectional view of a solid electrolyte sheet according to one embodiment of the present invention.

FIG. 2 is a schematic view of a process of forming a solid electrolyte sheet by drying an applied composition in a manufacturing method of a solid electrolyte sheet according to another embodiment of the present invention.

FIG. 3 is a schematic cross-sectional view of a stacking structure formed by a positive electrode (or a positive electrode composite), a negative electrode (or a negative electrode composite), and solid electrolyte sheets of an electrochemical cell (lithium rechargeable battery) according to another embodiment of the present invention.

FIG. 4 is a SEM image of a cross-section of a solid electrolyte sheet manufactured according to embodiment 1.

FIG. 5 is a SEM image of a cross-section of a solid electrolyte sheet manufactured according to Comparative Example 1.

### DETAILED DESCRIPTION OF THE EMBODIMENTS

The terms such as first, second, and third are used to describe various portions, components, regions, layers, and/or sections, but various parts, components, regions, layers, and/or sections are not limited to these terms. These terms are only used to distinguish one part, component, region, layer, or section from another part, component, region, layer, or section. Accordingly, a first part, component, region, layer, or section described below may be referred to as a second part, component, region, layer, or section without departing from the scope of the present invention.

Terminologies as used herein are to mention only a specific exemplary embodiment, and are not to limit the present invention. Singular forms used herein include plural forms as long as phrases do not clearly indicate an opposite meaning. The term “including/comprising/containing/having” as used herein concretely indicates specific characteristics, regions, integer numbers, steps, operations, elements, and/or components, and is not to exclude presence or addition of other specific characteristics, regions, integer numbers, steps, operations, elements, and/or components.

When any portion is referred to as being “above” or “on” another portion, any portion may be directly above or on another portion or be above or on another portion with the other portion interposed therebetween. In contrast, when any portion is referred to as being “directly on” another portion, the other portion is not interposed between any portion and another portion.

Unless defined otherwise, all terms including technical terms and scientific terms as used herein have the same meaning as the meaning generally understood by a person of an ordinary skill in the art to which the present invention pertains. Terms defined in a generally used dictionary are additionally interpreted as having the meaning matched to the related art document and the currently disclosed contents and are not interpreted as ideal or formal meaning unless defined.

Additionally, unless specifically stated, % means wt %, and 1 ppm is 0.0001 wt %.

In this specification, the term “combination thereof(s)” described in a Markush format expression means one or more mixtures or combinations selected from the group consisting of components described in the Markush format expression, and means including one or more selected from the group consisting of the components.

Below, an embodiment is described in detail so that a person of ordinary skill in the technical field to which the present invention belongs can easily carry out the present invention. As those skilled in the art would realize, the described embodiments may be modified in various different ways, all without departing from the spirit or scope of the present invention.

### 1. Solid Electrolyte Sheet

One embodiment of the present invention provides a solid electrolyte sheet including a first solid electrolyte layer and a second solid electrolyte layer disposed on the first solid electrolyte layer, wherein the first solid electrolyte layer includes the first solid electrolyte, the second solid electrolyte layer includes the second solid electrolyte, and a density of the first solid electrolyte is greater than the density of the second solid electrolyte, and a difference in the density of the first solid electrolyte and the second solid electrolyte is 0.15 to 1.65 g/cc.

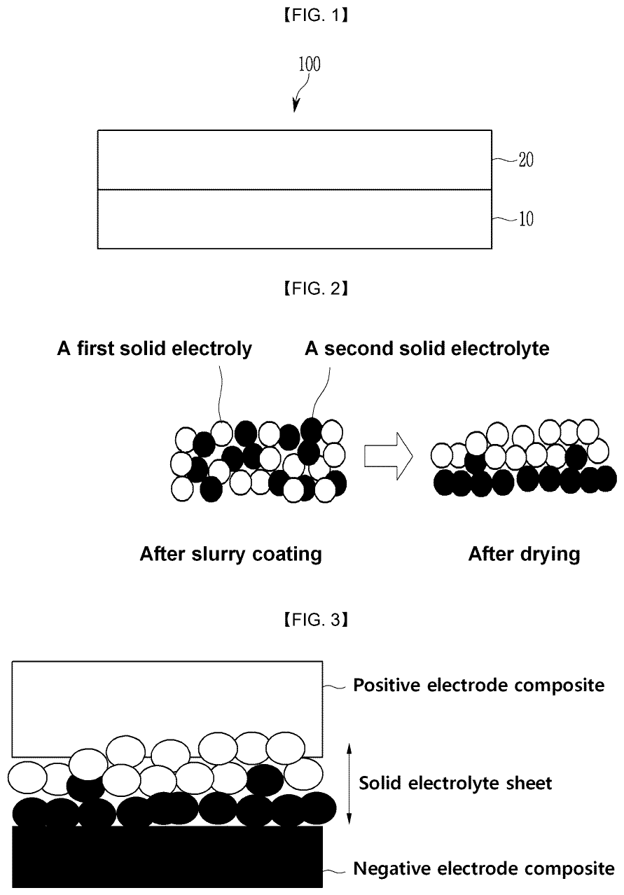

FIG. 1 is a schematic cross-sectional view of a solid electrolyte sheet according to one embodiment of the present invention.

Referring to FIG. 1, a solid electrolyte sheet 100 according to one embodiment of the present invention comprises a first solid electrolyte layer 10 and a second solid electrolyte layer 20 disposed on the first solid electrolyte layer.

The first solid electrolyte layer 10 contains the first solid electrolyte, and the second solid electrolyte layer 20 contains the second solid electrolyte.

In the present invention, the first solid electrolyte layer can be positioned on the positive electrode side when implemented in a lithium rechargeable battery, and the second solid electrolyte layer can be positioned on the negative electrode side.

Since the first solid electrolyte included in this first solid electrolyte layer comes into contact with the positive electrode active material, it must have good electrochemical stability with the positive electrode active material. More specifically, in order to form a wide contact area with the positive electrode active material, the particle size must be small, the interface resistance with the positive electrode active material must be small, and it must be stable at high voltage.

On the other hand, since the second solid electrolyte included in the second solid electrolyte layer is in contact with the negative electrode active material, it must have good electrochemical stability with the negative electrode active material. More specifically, it must have a wide contact area with the negative electrode active material, have a large particle size to facilitate ion transfer, have a small interface resistance with the negative electrode active material, and be stable at low voltage.

Particularly, the density of the first solid electrolyte is greater than that of the second solid electrolyte, and the difference in density between the first solid electrolyte and the second solid electrolyte is 0.15 to 1.65 g/cc.

The first solid electrolyte is a halide-based solid electrolyte or sulfide-based solid electrolyte with a halogen-rich composition, has high ion conductivity, and is electrochemically stable to the positive electrode active material. On the other hand, the second solid electrolyte is a stable sulfide-based solid electrolyte for the negative electrode, has a halogen-less composition and low ion conductivity, but uses a stable solid electrolyte for the negative electrode active material.

As the density of the first solid electrolyte is greater than that of the second solid electrolyte, the capacity, initial efficiency, and life-span characteristics of the battery can be improved. In addition, as described below, when manufacturing a solid electrolyte sheet according to the present invention, there is an excellent advantage in efficiency in the manufacturing process. More details will be provided later.

Particularly, the difference in density between the first solid electrolyte and the second solid electrolyte may be 0.15 to 1.65 g/cc, and more specifically, 1.0 to 1.65 g/cc or 1.0 to 1.5 g/cc. As the density difference is adjusted in this way, the effect can be maximized. More specifically, if the density difference is too large, the ionic conductivity of the solid electrolyte sheet may be degraded, and if the density difference is too small, the capacity, initial efficiency, and life-span characteristics of the battery may be degraded.

In this specification, the measurement of solid electrolyte density can be performed by applying a pressure of 20 MPa to the manufactured solid electrolyte powder to pelletize it, and then using the volume and weight under room temperature and the atmospheric pressure conditions.

The density of this first solid electrolyte can be more specifically 1.4 to 3.4 g/cc. If the density of the first solid electrolyte is too large, there is no problem of layer separation in the manufacturing process with the second solid electrolyte as described in the description of the manufacturing method described later, but the problem of reducing the energy density of the cell due to the increase in the solid electrolyte density and the problem of degrading the ion conductivity of the solid electrolyte sheet due to the density difference with the second solid electrolyte becoming too large, may occur. On the other hand, if the density of the first solid electrolyte is too low, it may be difficult to separate the layers from the second solid electrolyte during the manufacturing process described later, and the density difference with the second solid electrolyte is too small, so that the capacity, initial efficiency, and life-span characteristics of the battery may be degraded.

Additionally, the density of the second solid electrolyte can be more specifically 1.1 to 2.1 g/cc. If the density of the second solid electrolyte is too large, it may be difficult to separate the layers from the first solid electrolyte, and the density difference with the first solid electrolyte is too small, so that the capacity, initial efficiency, and life-span characteristics of the battery may deteriorate. On the other hand, if the density of the second solid electrolyte is too small, it may float above the solvent surface, and the density difference with the first solid electrolyte becomes too large, so that the ion conductivity of the solid electrolyte sheet may deteriorate.

This first solid electrolyte can be a halide-based solid electrolyte, a sulfide-based solid electrolyte, or a combination thereof. Since the first solid electrolyte is a halide-based solid electrolyte or a sulfide-based solid electrolyte, the above-mentioned required characteristics as a first solid electrolyte can be satisfied. That is, since the interface resistance with the positive electrode active material is small and stable at high voltage, the ion conductivity of the solid electrolyte sheet and the electrochemical characteristics of the battery can be excellent.

More specifically, the halide-based solid electrolyte can be represented by the following formula 1.

LiₓM_{y}A_{z} [Chemical Formula 1]

In the above formula 1, M is Sc, In, Zr, Lu, Er, Y, Ho or combination thereof, A is F, Cl, Br, I or combination thereof, 1.5≤x≤3.5, 0.5≤y≤1.5, and 5≤z≤7.

For example, the halide-based solid electrolyte can be Li₃InCl₆, Li₂ZrCl₆, Li₃ScCl₆, Li₂ErCl₆, Li₂LuCl₆, Li₂HoCl₆, etc., but is not limited thereto.

The sulfide-based solid electrolyte can have an argyrodite crystal structure. Among sulfide-based solid electrolytes, it can have excellent ion conductivity due to its particularly argyrodite-based crystal structure.

More specifically, the sulfide-based solid electrolyte can be represented by the following formula 2.

Li₆₋ₓPS₅₋ₓD₁₊ₓ [Chemical Formula 2]

In the above formula 2, 0≤x≤1, and D is F, Cl, B, I or combination thereof.

For example, the sulfide-based solid electrolyte can be Li₆PS₅Cl, Li_{5.7}PS_{4.7}Cl_{1.3}, Li_{5.5}PS_{4.5}Cl_{1.5}, etc., but is not limited thereto.

Preferably, the size of the first solid electrolyte particle can be less than 3 μm. Since the size of the first solid electrolyte particle is sufficiently small, a wide contact area can be formed with the positive electrode active material.

In this specification, “particle size” means the average particle diameter when the particle, such as a solid electrolyte or positive electrode active material, has a spherical shape, and the major axis length when the particle has a non-spherical shape.

Meanwhile, the second solid electrolyte may be a sulfide-based solid electrolyte. Since the second solid electrolyte is a sulfide-based solid electrolyte, the above-mentioned required characteristics as a second solid electrolyte can be satisfied. That is, since the interface resistance with the negative electrode active material is small and stable at low voltage, the ion conductivity of the solid electrolyte sheet and the electrochemical characteristics of the battery can be excellent.

The sulfide-based solid electrolyte can have an argyrodite crystal structure.

The sulfide-based solid electrolyte can be represented by the following formula 3.

Li₆₋ₓPS₅₋ₓE₁₊ₓ [Chemical Formula 3]

In the above formula 3, 0≤x≤1, and E is F, Cl, B, I or combination thereof.

Preferably, the size of the second solid electrolyte particle can be 3 μm to 10 μm. Since the size of the second solid electrolyte particle is sufficiently large, a wide contact area can be formed with the negative electrode active material, facilitating ion transfer.

Meanwhile, the weight ratio of the first solid electrolyte and the second solid electrolyte can be 3:7 to 7:3. If the content of the first solid electrolyte is too small, the first solid electrolyte layer may not completely cover the second solid electrolyte layer, which may cause a problem in which the second solid electrolyte layer comes into contact with the positive electrode. If the content of the second solid electrolyte is too large, the second solid electrolyte layer may not completely cover the first solid electrolyte layer, which may cause a problem in which the first solid electrolyte layer comes into contact with the negative electrode. In this way, if the second solid electrolyte layer comes into contact with the positive electrode or the first solid electrolyte layer comes into contact with the negative electrode, an electrochemical reaction may occur, which may degrade the battery characteristics.

### 2. Method of Manufacturing Solid Electrolyte Sheet

FIG. 2 is a flowchart of a manufacturing method of a solid electrolyte sheet according to another embodiment of the present invention.

Referring to FIG. 2, another embodiment of the present invention provides a method for manufacturing a solid electrolyte sheet, comprising the steps of forming a composition including a first solid electrolyte, a second solid electrolyte, a solvent, and a binder; applying the composition onto a substrate; and drying the applied composition to form a solid electrolyte sheet, wherein a density of the first solid electrolyte is greater than a density of the second solid electrolyte, and a difference in the density of the first solid electrolyte and the second solid electrolyte is 0.15 to 1.65 g/cc.

Below, a manufacturing method of a solid electrolyte sheet according to another embodiment of the present invention is described in detail step by step.

First, a composition is formed that includes a first solid electrolyte, a second solid electrolyte, a solvent, and a binder.

At this time, the density of the first solid electrolyte is greater than the density of the second solid electrolyte, and the difference in density between the first solid electrolyte and the second solid electrolyte is 0.15 to 1.65 g/cc. The merits of this will be explained in more detail in the drying step described later.

The first solid electrolyte can be a halide-based solid electrolyte or a sulfide-based solid electrolyte.

More specifically, the halide-based solid electrolyte can be represented by the following formula 1.

LiₓM_{y}A_{z} [Chemical Formula 1]

In the above formula 1, M is Sc, In, Zr, Lu, Er, Y, Ho or combination thereof, A is F, Cl, Br, I or combination thereof, 1.5≤x≤3.5, 0.5≤y≤1.5, and 5≤z≤7.

For example, the halide-based solid electrolyte can be Li₃InCl₆, Li₂ZrCl₆, Li₃ScCl₆, Li₂ErCl₆, Li₂LuCl₆, Li₂HoCl₆, etc., but is not limited thereto.

The sulfide-based solid electrolyte can have an argyrodite crystal structure.

More specifically, the sulfide-based solid electrolyte can be represented by the following formula 2.

Li₆₋ₓPS₅₋ₓD₁₊ₓ [Chemical Formula 2]

In the above formula 2, 0≤x≤1, and D is F, Cl, B, I or combination thereof.

For example, the sulfide-based solid electrolyte can be Li₆PS₅Cl, Li_{5.7}PS_{4.7}Cl_{1.3}, Li_{5.5}PS_{4.5}Cl_{1.5}, etc., but is not limited thereto.

Preferably, the size of the first solid electrolyte particle can be less than 3 μm. The benefits of this are as described above, so they are omitted.

The second solid electrolyte may be a sulfide-based solid electrolyte.

The sulfide-based solid electrolyte can have an argyrodite crystal structure.

The sulfide-based solid electrolyte can be represented by the following formula 3.

Li₆₋ₓPS₅₋ₓE₁₊ₓ [Chemical Formula 3]

In the above formula 3, 0≤x≤1, and E is F, Cl, B, I or combination thereof.

Preferably, the size of the second solid electrolyte particle can be 3 μm to 10 μm. The benefits of this are as described above, so they are omitted.

The density of the first solid electrolyte can be 1.4 to 3.4 g/cc. The benefits of this are as described above, so they are omitted.

The density of the second solid electrolyte can be 1.1 to 2.1 g/cc. The benefits of this are as described above, so they are omitted.

Meanwhile, the weight ratio of the first solid electrolyte and the second solid electrolyte can be 3:7 to 7:3. The benefits of this are as described above, so they are omitted.

The solvent is not particularly limited as long as it is used as a solvent for a solid electrolyte in the relevant technical field, but for example, one or more selected from xylene, toluene and Isobutyl isobutyrate may be used, but is limited thereto.

The binder is not particularly limited as long as it is used as a binder in the relevant technical field. For example, one or more selected from nitrile butadiene rubber (NBR), PTFE, styrene-butadiene-styrene copolymer, acryl-based resin, styrene-butadiene rubber (SBR), polytetrafluoroethylene, polyvinylidene fluoride, polyethylene, vinylidenefluoride/hexafluoropropylene copolymer, polyacrylonitrile, and polymethylmethacrylate can be used, but is not limited thereto.

Of course, it is possible to form a composition that further includes other additives to improve other characteristics as needed.

Next, the composition is applied onto the substrate.

The material of the description is not particularly limited as long as it is chemically stable with respect to the slurry.

For example, the substrate may include one or more selected from PET (polyethylene terephthalate), PEN (polyethylenenaphthalate), PES (polyethersulfone), PC (polycarbonate), PP (polypropylene), porous non-woven fabric, but is not limited thereto.

Next, the applied composition is dried to form a solid electrolyte sheet.

FIG. 2 is a schematic view of the process of forming a solid electrolyte sheet by drying the applied composition.

Referring to FIG. 2, as mentioned above, the density of the first solid electrolyte is greater than that of the second solid electrolyte. At this time, the first solid electrolyte and the second solid electrolyte, which were uniformly dispersed and mixed in the slurry formation stage, are naturally separated due to the density difference during the drying and form layers. As a result, a first solid electrolyte layer including a first solid electrolyte and a second solid electrolyte layer including a second solid electrolyte disposed on the first solid electrolyte layer, can be formed.

Conventional art adopts a successive lamination method in which, when forming a solid electrolyte sheet or laminate using two types of solid electrolytes, a first layer is formed, and then a second layer is formed on the first layer. This successive layering method had the problem of poor process efficiency. On the other hand, the solid electrolyte manufacturing method according to the present invention forms a composition including both a first solid electrolyte and a second solid material, and then forms a laminate of a first solid electrolyte layer and a second solid electrolyte layer in one step through a natural separation process due to the difference in density of the first solid electrolyte and the second solid electrolyte. Therefore, the process has the advantage of excellent efficiency.

Particularly, when the difference in density between the first solid electrolyte and the second solid electrolyte is 0.15 to 1.65 g/cc, the laminate formation through the separation process can be efficiently achieved. More specifically, if the density difference is too small, the first solid electrolyte and the second solid electrolyte may mix without layer separation, and if the density difference is too large, the first solid electrolyte layer and the second solid electrolyte layer may detach after drying.

The method of this coating process is not particularly limited as long as it is commonly used in the relevant technical field, but for example, blade coating can be used.

### 3. Electrochemical Cell

Another embodiment of the present invention provides an electrochemical cell including a positive electrode; a negative electrode; and a solid electrolyte sheet positioned between the positive electrode and the negative electrode, wherein the solid electrolyte sheet includes a first solid electrolyte layer and a second solid electrolyte layer disposed on the first solid electrolyte layer, wherein the first solid electrolyte layer includes a first solid electrolyte, the second solid electrolyte layer includes a second solid electrolyte, a density of the first solid electrolyte is greater than a density of the second solid electrolyte, and a density difference between the first solid electrolyte and the second solid electrolyte is 0.15 to 1.65 g/cc, and the first solid electrolyte layer is positioned on the positive electrode side and the second solid electrolyte layer is positioned on the negative electrode side.

The electrochemical cell is not particularly limited, but may be, for example, a lithium rechargeable battery.

FIG. 3 is a schematic cross-sectional view of a stacking structure formed by a positive electrode (or a positive electrode composite), a negative electrode (or a negative electrode composite), and solid electrolyte sheets of an electrochemical cell (lithium rechargeable battery) according to another embodiment of the present invention.

Referring to FIG. 3, the first solid electrolyte layer including the first solid electrolyte can be positioned on the positive electrode side (positive electrode composite), and the second solid electrolyte layer can be positioned on the negative electrode side (negative electrode composite).

As described above, the electrochemical characteristics of a rechargeable battery can be improved as the first solid electrolyte layer having excellent interface characteristics with a positive electrode is positioned on the positive electrode side, and the second solid electrolyte layer having excellent interface characteristics with a negative electrode is positioned on the negative electrode side.

Below, an implementation example of the present invention is described in more detail through embodiment. However, the following embodiment is only a preferable embodiment, and the present invention is not limited by the following embodiment.

### Comparative Example 1: 1-Type Li₆PS₅Cl Solid Electrolyte Sheet

### (1) Manufacturing of Solid Electrolytes

Li₆PS₅Cl is synthesized via dry milling. Specifically, the dry milling was performed by measuring Li₂S, P₂S₅, and LiCl according to the composition, mixing them at 300 rpm for 8 hours using a high-viscosity mill (Planetary Mill), and then producing a pellet at 300 MPa, which was then heat treated at 550° C. in an argon atmosphere to synthesize Li₆PS₅Cl, argyrodite-based solid electrolyte. The density was measured by measuring the volume and mass of the pellet of the manufactured solid electrolyte. The density of the manufactured solid electrolyte was 1.4 g/cc under the atmospheric pressure and room temperature conditions.

### (2) Solid Electrolyte Sheet Manufacturing

The synthesized solid electrolyte was mixed with 3 wt % NBR binder dissolved in xylene to form a slurry (composition).

Afterwards, the slurry (composition) was applied onto the PET substrate using blade coating.

Afterwards, the applied slurry (composition) was dried at 50° C. to form a solid electrolyte sheet.

### (3) Lithium Rechargeable Battery Manufacturing

Electrochemical evaluation of solid electrolyte sheets was performed using a compressed powder cell. The solid electrolyte sheet is cut into an area of 0.785 cm², separated from the PET carrier film, and only the solid electrolyte sheet is placed in a compressed powder cell, and then a composite electrode is loaded on top. The composite electrode was manufactured with a positive electrode:solid electrode:conductive material (denka black)=70:29:1 wt %, and a loading of 20.0 mg over an area of 0.785 cm², and the density was increased by 300 MPa. Afterwards, the junction was made at 50 MPa using an In—Li counter electrode, and the cell was engaged at the same pressure.

### Comparative Example 2: 1-Type Li_{5.7}PS_{4.7}Cl_{1.3} Solid Electrolyte Sheet

A solid electrolyte, a solid electrolyte sheet, and a lithium rechargeable battery were manufactured in the same manner as in Comparative Example 1, except that the composition of Li₂S, P₂S₅, and LiCl was changed to synthesize Li_{5.7}PS_{4.7}Cl_{1.3} solid electrolyte. The density of the manufactured solid electrolyte was 1.6 g/cc under the atmospheric pressure and room temperature conditions.

### Comparative Example 3: 1-Type Li_{5.5}PS_{4.5}Cl_{1.5} Solid Electrolyte Sheet

A solid electrolyte, a solid electrolyte sheet, and a lithium rechargeable battery were manufactured in the same manner as in Comparative Example 1, except that the composition of Li₂S, P₂S₅, and LiCl was changed to synthesize Li_{5.5}PS_{4.5}Cl_{1.5} solid electrolyte. The density of the manufactured solid electrolyte was 1.8 g/cc under the atmospheric pressure and room temperature conditions.

### Comparative Example 4: 1-Type Li₃InCl₆ Solid Electrolyte Sheet

### (1) Manufacturing of Solid Electrolytes

Li₃InCl₆, a halide-based solid electrolyte, was synthesized by dry milling/mixing LiCl and InCl₃ according to the composition, drying in vacuum, and then heat treating at 270° C. The powder ion conductivity of Li₃InCl₆ is 0.63 mS/cm and the electron conductivity is 1.52×10⁻⁹ S/cm. The density of the manufactured solid electrolyte was 3 g/cc under the atmospheric pressure and room temperature conditions.

### (2) Solid Electrolyte Sheet and Lithium Rechargeable Battery Manufacturing

A solid electrolyte sheet and a lithium rechargeable battery were manufactured in the same manner as in Comparative Example 1, except that the synthesized Li₃InCl₆ solid electrolyte was used.

### Embodiment 1: Li₃InCl₆ and Li₆PS₅Cl 50:50 wt % 2-Type Solid Electrolyte Sheet

### (1) Manufacturing of Solid Electrolytes

Li₆PS₅Cl solid electrolyte and Li₃InCl₆ solid electrolyte were manufactured using the same method as in Comparative Example 1 and Comparative Example 4.

### (2) Manufacturing of Solid Electrolyte Sheet

A composition (slurry) was formed by mixing Li₃InCl₆ solid electrolyte as the first solid electrolyte, Li₆PS₅Cl solid electrolyte as the second solid electrolyte (50:50 parts by weight), and 3 wt % NBR binder dissolved in xylene.

Afterwards, the composition (slurry) was applied on a polyethyl terephthalate PET substrate as a PET carrier film using a method of blade coating.

Thereafter, the applied composition (slurry) was dried at 50° C. to manufacture a solid electrolyte sheet including a first solid electrolyte layer including a first solid electrolyte and a second solid electrolyte layer including a second solid electrolyte.

### (3) Manufacturing of Lithium Rechargeable Battery

Electrochemical evaluation of solid electrolyte sheets was performed using a compressed powder cell. The solid electrolyte sheet is cut into an area of 0.785 cm², separated from the PET carrier film, and only the solid electrolyte sheet is placed in a compressed powder cell, and then a composite electrode is loaded on top. The composite electrode was manufactured with a positive electrode active material:solid electrode:conductive material (denka black)=70:29:1 wt %, and a loading of 20.0 mg over an area of 0.785 cm², and the density was increased by 300 MPa. Afterwards, the junction was made at 50 MPa using an In—Li counter electrode, and the cell was engaged at the same pressure. At this time, the first solid electrolyte layer was positioned on the composite electrode side, and the second solid electrolyte layer was positioned on the In—Li counter electrode side.

### Embodiment 2: Li₃InCl₆ and Li_{5.7}PS_{4.7}Cl_{1.3}50:50 wt % 2-Type Solid Electrolyte Sheet

A solid electrolyte sheet and a lithium rechargeable battery were manufactured in the same manner as in embodiment 1, except that the Li₃InCl₆ solid electrolyte manufactured according to Comparative Example 4 was used as the first solid electrolyte and the Li_{5.7}PS_{4.7}Cl_{1.3} solid electrolyte manufactured according to Comparative Example 2 was used as the second solid electrolyte.

### Embodiment 3: Li₃InCl₆ and Li_{5.5}PS_{4.5}Cl_{1.5}50:50 wt % 2-Type Solid Electrolyte Sheet

A solid electrolyte sheet and a lithium rechargeable battery were manufactured in the same manner as in embodiment 1, except that the Li₃InCl₆ solid electrolyte manufactured according to Comparative Example 4 was used as the first solid electrolyte and the Li_{5.5}PS_{4.5}Cl_{1.5} solid electrolyte manufactured according to Comparative Example 3 was used as the second solid electrolyte.

### Embodiment 4: Li_{5.5}PS_{4.5}Cl_{1.5} and Li₆PS₅Cl 50:50 wt % 2-Type Solid Electrolyte Sheet

A solid electrolyte sheet and a lithium rechargeable battery were manufactured in the same manner as in embodiment 1, except that the Li_{5.5}PS_{4.5}Cl_{1.5} solid electrolyte manufactured according to Comparative Example 3 was used as the first solid electrolyte and the Li₆PS₅Cl solid electrolyte manufactured according to Comparative Example 1 was used as the second solid electrolyte.

### Embodiment 5: Li_{5.5}PS_{4.5}Cl_{1.5} and Li_{5.7}PS_{4.7}Cl_{1.3}50:50 wt % 2-Type Solid Electrolyte Sheet

A solid electrolyte sheet and a lithium rechargeable battery were manufactured in the same manner as in embodiment 1, except that the Li_{5.5}PS_{4.5}Cl_{1.5} solid electrolyte manufactured according to Comparative Example 3 was used as the first solid electrolyte and the Li_{5.7}PS_{4.7}Cl_{1.3} solid electrolyte manufactured according to Comparative Example 2 was used as the second solid electrolyte.

### Comparative Example 5

A solid electrolyte sheet and a lithium rechargeable battery were manufactured in the same manner as in embodiment 1, except that the Li₆PS₅Cl solid electrolyte was positioned on the In—Li counter electrode side and the Li₃InCl₆ solid electrolyte was positioned on the composite electrode side of the manufactured solid electrolyte sheet.

### Experimental Example 1: SEM Image Analysis of Solid Electrolyte Sheet

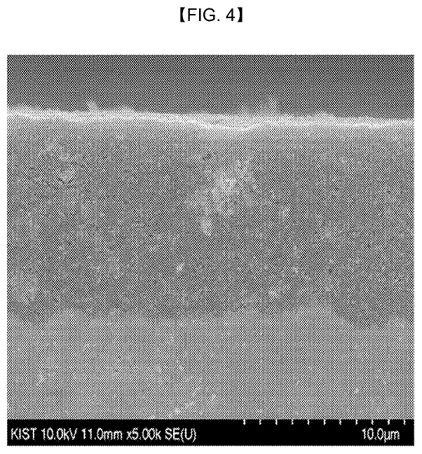

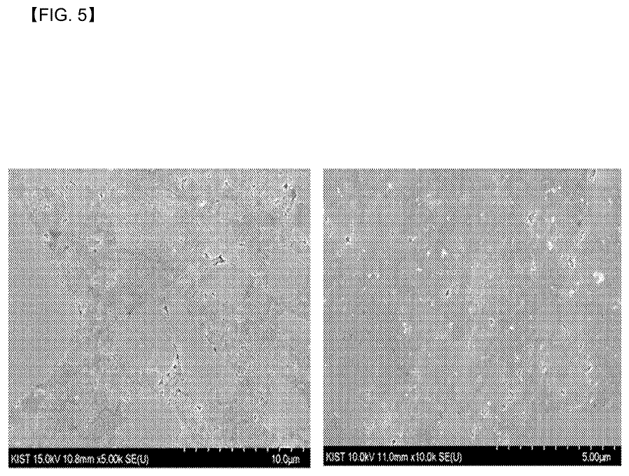

The cross-sections of the solid electrolyte sheets manufactured according to embodiment 1 and Comparative Example 1 were observed using a scanning electron microscope (SEM), and the results are shown in FIG. 4 (embodiment 1) and FIG. 5 (Comparative Example 1).

Referring to FIG. 4 and FIG. 5, it was confirmed that the solid electrolyte sheet according to embodiment 1 was a laminate structure formed by separating the first solid electrolyte layer and the second solid electrolyte layer. On the other hand, it was confirmed that the solid electrolyte sheet according to Comparative Example 1 was in a simple mixed state without distinction of solid electrolytes.

### Experimental Example 2: Evaluation of Ion Conductivity of Solid Electrolyte Sheet

An experiment was conducted to evaluate the ion conductivity of the solid electrolyte sheets manufactured according to Embodiments 1 to 5 and Comparative Examples 1 to 4, and the results are shown in Table 1 below.

Specifically, the synthesized solid electrolyte was pulverized and then produced in a pellet form under 300 MPa pressure. After that, a cell was manufactured using SUS as a working electrode at a pressure of 70 MPa. After that, the impedance was measured by applying a voltage of 10 mV at 30° C.

TABLE 1

| | | | | | | | Difference | Ion |
|---|---|---|---|---|---|---|---|---|
| | First solid | Density | Weight | Second solid | Density | Weight ratio | of density | conductivity |
| | electrolyte | (g/cc) | ratio (wt %) | electrolyte | (g/cc) | (wt %) | (g/cc) | (mS/cm) |
| Comparative | Li₆PS₅Cl | 1.4 | 100 | — | — | — | — | 0.4 |
| Example 1 | | | | | | | | |
| Comparative | Li_{5.7}PS_{4.7}Cl_{1.3} | 1.6 | 100 | — | — | — | — | 1.5 |
| Example 2 | | | | | | | | |
| Comparative | Li_{5.5} PS_{4.5}Cl_{1.5} | 1.8 | 100 | — | — | — | — | 2 |
| Example 3 | | | | | | | | |
| Comparative | Li₃InCl₆ | 3 | 100 | — | — | — | — | 0.2 |
| Example 4 | | | | | | | | |
| Comparative | Li₆PS₅Cl | 1.4 | 50 | Li₃InCl₆ | 3 | 50 | −1.6 | 0.3 |
| Example 5 | | | | | | | | |
| embodiment 1 | Li₃InCl₆ | 3 | 50 | Li₆PS₅Cl | 1.4 | 50 | 1.6 | 0.3 |
| embodiment 2 | Li₃InCl₆ | 3 | 50 | Li_{5.7}PS_{4.7}Cl_{1.3} | 1.6 | 50 | 1.4 | 1.1 |
| embodiment 3 | Li₃InCl₆ | 3 | 50 | Li_{5.5}PS_{4.5}Cl_{1.5} | 1.8 | 50 | 1.2 | 1.6 |
| embodiment 4 | Li_{5.5}PS_{4.5}Cl_{1.5} | 1.8 | 50 | Li₆PS₅Cl | 1.4 | 50 | 0.4 | 1.2 |
| embodiment 5 | Li_{5.5}PS_{4.5}Cl_{1.5} | 1.8 | 50 | Li_{5.7}PS_{4.7}Cl_{1.3} | 1.6 | 50 | 0.2 | 1.7 |

Referring to Table 1, it was confirmed that the ion conductivities of the solid electrolyte sheets manufactured according to embodiments 1 to 5 were generally excellent, but the ion conductivities of Comparative Examples 1 and 4 were very poor.

### Experimental Example 3: Evaluation of Lithium Rechargeable Battery Electrochemical Characteristic

The lithium rechargeable batteries manufactured according to Embodiments 1 to 5 and Comparative Examples 1 to 4 were subjected to an electrochemical characteristic evaluation experiment using a compressed powder cell, and the results are shown in Table 2 below. The specific experiment method is as follows.

### (1) Evaluation of Initial Charge Capacity, Discharge Capacity and Initial Efficiency

After manufacturing the battery, it was aged at room temperature for 2 hours and then a charge and discharge test was performed. Capacity evaluation was conducted with 180 mAh/g as the reference capacity, and charging and discharging conditions were applied as CC/CV 1.9-3.60 V, 1/20C cut-off. The initial capacity was performed under 0.1C charge/0.1 C discharge condition.

### (2) Life-Span Characteristic Evaluation

The life-span characteristic was evaluated by calculating the percentage of discharge capacity after 30 charging and discharging cycles for the initial discharge capacity.

TABLE 2

| | Difference | 0.1 C | 0.1 C | Initial | Life-span |
|---|---|---|---|---|---|
| | of | charge | discharge | effi- | (30^{th} |
| | density | capacity | capacity | ciency | cycle, |
| | (g/cc) | (mAh/g) | (mAh/g) | (%) | 30 °C) |
| Comparative | — | 208 | 165 | 79 | 77 |
| Example 1 | | | | | |
| Comparative | — | 209 | 171 | 82 | 79 |
| Example 2 | | | | | |
| Comparative | — | 213 | 173 | 81 | 78 |
| Example 3 | | | | | |
| Comparative | — | 206 | 158 | 77 | 76 |
| Example 4 | | | | | |
| Comparative | −1.6 | 202 | 145 | 72 | 65 |
| Example 5 | | | | | |
| embodiment 1 | 1.6 | 215.1 | 175.5 | 82 | 88 |
| embodiment 2 | 1.4 | 216.5 | 175.2 | 81 | 84 |
| embodiment 3 | 1.2 | 214.6 | 174.9 | 82 | 82 |
| embodiment 4 | 0.4 | 210 | 170 | 81 | 80 |
| embodiment 5 | 0.2 | 209 | 168 | 80 | 78 |

Referring to Table 2, it was confirmed that the lithium rechargeable batteries according to embodiments 1 to 5 had generally excellent charge capacity, discharge capacity, initial efficiency, and life-span characteristics compared to the lithium rechargeable batteries according to comparative examples 1 to 5. Particularly, it was confirmed that the lithium rechargeable battery according to embodiments 1 to 3 had excellent charge capacity, discharge capacity, initial efficiency, and life-span characteristics. In addition, it was confirmed that the lithium rechargeable battery according to Comparative Example 5 had very poor charge capacity, discharge capacity, initial efficiency, and life-span characteristics as a result of the density of the first solid electrolyte being lower than that of the second solid electrolyte.

Although the present invention has been described above with regard to a preferably embodiment thereof, the present invention is not limited thereto, and it is possible to implement the present invention by modifying it in various ways within the scope of the patent claims and the detailed description and accompanying drawings of the invention, and this also naturally falls within the scope of the present invention.

Therefore, it can be said that the actual scope of the present invention is defined by the attached patent claims and their equivalents.

| | |
|---|---|
| 10: first solid electrolyte layer | 100: solid electrolyte sheet |
| 20: second solid electrolyte layer | |

What is claimed is:

1. A solid electrolyte sheet, comprises:
a first solid electrolyte layer and a second solid electrolyte layer arranged on the first solid electrolyte layer, wherein, the first solid electrolyte layer comprises a first solid electrolyte, and the second solid electrolyte layer comprises a second solid electrolyte,
a density of the first solid electrolyte is greater than that of the second solid electrolyte, and a difference in density between the first solid electrolyte and the second solid electrolyte is 0.15 to 1.65 g/cc.

2. The solid electrolyte sheet of claim 1, wherein:
a density of the first solid electrolyte is 1.4 to 3.4 g/cc.

3. The solid electrolyte sheet of claim 1, wherein:
a density of the second solid electrolyte is 1.1 to 2.1 g/cc.

4. The solid electrolyte sheet of claim 1, wherein:
a weight ratio of the first solid electrolyte and the second solid electrolyte is 3:7 to 7:3.

5. The solid electrolyte sheet of claim 1, wherein:
the first solid electrolyte is a halide-based solid electrolyte, a sulfide-based solid electrolyte or combination thereof.

6. The solid electrolyte sheet of claim 5, wherein:
the halide-based solid electrolyte is represented by the following formula 1,
the sulfide-based solid electrolyte has an argyrodite crystal structure and is represented by the following formula 2:
LiₓM_{y}A_{z} [Chemical Formula 1]
Li₆₋ₓPS₅₋ₓD₁₊ₓ [Chemical Formula 2]
in the above formula 1, M is Sc, In, Zr, Lu, Er, Y, Ho or combination thereof, A is F, Cl, Br, I or combination thereof, 1.5≤x≤3.5, 0.5≤y≤1.5, and 5≤z≤7,
in the above formula 2, 0≤x≤1, and D is F, Cl, B, I or combination thereof.

7. The solid electrolyte sheet of claim 1, wherein:
the second solid electrolyte is a sulfide-based solid electrolyte.

8. The solid electrolyte sheet of claim 7, wherein:
the sulfide-based solid electrolyte has an argyrodite crystal structure and is represented by the following formula 3:
Li₆₋ₓPS₅₋ₓE₁₊ₓ [Chemical Formula 3]
in the above formula 3, 0≤x≤1, and E is F, Cl, B, I or combination thereof.

9. A method of manufacturing a solid electrolyte sheet, comprises:
forming a composition including a first solid electrolyte, a second solid electrolyte, a solvent, and a binder;
applying the composition onto a substrate; and
drying the applied composition to form a solid electrolyte sheet;
wherein, a density of the first solid electrolyte is greater than that of the second solid electrolyte, and a difference in density between the first solid electrolyte and the second solid electrolyte is 0.15 to 1.65 g/cc.

10. The method of claim 9, wherein:
a density of the first solid electrolyte is 1.4 to 3.4 g/cc.

11. The method of claim 9, wherein:
a density of the second solid electrolyte is 1.1 to 2.1 g/cc.

12. The method of claim 9, wherein:
a weight ratio of the first solid electrolyte and the second solid electrolyte is 3:7 to 7:3.

13. The method of claim 9, wherein:
the step of forming a solid electrolyte sheet by drying the applied composition is performed that:
the first solid electrolyte and the second solid electrolyte are separated by a difference in density, and
the second solid electrolyte comprising the second solid electrolyte is arranged on the first solid electrolyte layer comprising the first solid electrolyte, during the drying.

14. An electrochemical cell, comprises:
a positive electrode; a negative electrode; and a solid electrolyte sheet positioned between the positive electrode and the negative electrode,
wherein, the solid electrolyte sheet comprises a first solid electrolyte layer and a second solid electrolyte layer disposed on the first solid electrolyte layer,
the first solid electrolyte layer comprises a first solid electrolyte, the second solid electrolyte layer comprises a second solid electrolyte,
a density of the first solid electrolyte is greater than that of the second solid electrolyte, and a difference in density between the first solid electrolyte and the second solid electrolyte is 0.15 to 1.65 g/cc, and
the first solid electrolyte layer is positioned on the positive electrode side, and the second solid electrolyte layer is positioned on the negative electrode side.

15. An electric vehicle comprises the electrochemical cell according to claim 14.
